(19) United States
(12) Patent Application Publication
(10) Pub. No.: US 2013/0328330 A1
(43) Pub. Date: Dec. 12, 2013

(54) LATCH MECHANISM SYSTEM FOR EARTHQUAKE AND CHILD PROOFING A CABINET

(71) Applicant: Dennis McKenzie, Pacific Palisades, CA (US)

(72) Inventor: Dennis McKenzie, Pacific Palisades, CA (US)

(21) Appl. No.: 13/493,869

(22) Filed: Jun. 11, 2012

(51) Int. Cl. E05C 3/14

(52) U.S. Cl. 292/202; 7/138

(57) ABSTRACT

A latch mechanism system for earthquake and child proofing cabinet door is disclosed. The latch mechanism can be connected to a preexisting cabinet door and either a preexisting or a new door handle. The latch mechanism system can be set with a preferred frictional resistance to increase or decrease the difficulty of turning the door handle in order to open the cabinet door.

### BACKGROUND

1. Field

This invention relates to a latch mechanism system, and in particular to a latch mechanism system for earthquake and child proofing a cabinet door.

2. Description of the Related Art

Cabinets are commonplace in many households to store items, as well as used in boats, recreational vehicles, etc. However, most cabinet doors are not built to prevent opening of the cabinet, such as prevent a child or an earthquake from opening the cabinet door. The cabinet could store valuable breakable items or items that would be harmful to a child. Therefore, a person may want to keep the cabinet from being opened by a child or during an earthquake.

Two general systems have been built to prevent opening of a cabinet door. The first system involves the installation of a full lock into the cabinet. However, installation of a full lock can be unnecessary and expensive if the owner only wants minor protection for the items in the cabinet. Additionally, a lock would require the use of a key or a password to open, making it inconvenient and cumbersome to open the cabinet door quickly. Furthermore, installation of a lock can be a complicated process.

Another system to accomplish proofing is to install a standard childproofing device into the door. However, a problem with many of these devices is the fact that the cabinet needs to be slightly opened in order to open the cabinet. A person must reach in through a gap between the cabinet and the frame in order to unlock the cabinet. A person must then deactivate the childproofing device, such as by flicking a lever or pressing down a button. Because the cabinet door must be opened slightly to deactivate the childproofing device, a child could still insert their fingers into the cabinet, and the fingers could get caught between the door and the frame, causing harm to the child's hand. The same could happen to an adult who is trying to open the cabinet. The current child and earthquake proofing devices for cabinets can also be troubling to elderly persons or persons lacking hand dexterity, as they may lack the necessary ability to open up the cabinet doors which require the use of a small switch or button or lever. Additionally, existing child proofing cabinet devices are often difficult to install as they require drilling additional holes in the cabinet and placement and alignment of the latch device so that it engages a corresponding catch that is also installed in the cabinet. Moreover, such devices often become loose after a short period of use, and must be regularly adjusted or replaced.

Therefore, both systems used to prevent a cabinet door from opening have numerous drawbacks. It would be useful to have a device to child proof and earthquake proof a cabinet door which is simple, safe, easy to install, and does not require large amounts of hand dexterity.

### SUMMARY

In some embodiments, a latch mechanism system for earthquake and child proofing an existing cabinet door is disclosed. The latch mechanism system can comprise a pair of tensioning members sized to fit within a hole in a cabinet door from which a pre-existing screw fastening a preexisting cabinet door handle has been removed. The pair of members can have a combined length greater than a width of the cabinet door. The latch mechanism system can also comprise a threaded screw having a longitudinal axis and a lever arm having a threaded hole at one end and configured to threadably couple to the screw. The lever arm can extend generally perpendicular to the longitudinal axis of the screw. The latch mechanism system can further comprise a spacer configured to receive the screw therethrough. The spacer can be positionable between a rear surface of the cabinet door and the lever arm. The latch mechanism system can further comprise a nut configured to threadably couple with the screw on an opposite side of the lever from the spacer so the nut can lock the lever arm against the spacer. The latch mechanism system can further comprise a stopper configured to affix to the cabinet door at a location laterally spaced apart from the axis of the screw. The stopper can be configured to stop movement of the lever arm.

The screw can be configured to extend through the pair of tensioning members and to couple with the preexisting door handle so that the screw extends in the same axis as the door handle. The lever arm can be configured to be rotated relative to the screw by a user rotating the door handle of the cabinet door, so as to compress the pair of tensioning members thereby frictionally engaging the door handle to the lever arm and causing the lever arm to rotate along with the door handle when the user rotates the door handle to latch and unlatch the cabinet door.

In some embodiments, a latch mechanism system for retrofitting an existing cabinet door to make the cabinet door earthquake and child proof is disclosed. The latch mechanism system can comprise a screw configured to extend through a hole in a cabinet door and configured to couple with a door handle. The latch mechanism can further comprise at least one tensioning member configured to generate a friction force on the screw and a lever arm coupled with an end of the screw on an opposite side of the cabinet door from the door handle. The lever arm can be configured to extend generally perpendicular to the screw. The latch mechanism system can further comprise a stopper affixed to the back of the cabinet at a location spaced apart from the axis of the screw to stop rotation of the lever arm. The lever arm can be frictionally engaged to the door handle via the screw and at least one tensioning member so that the lever arm rotates in unison with rotation of the door handle by a user.

In some embodiments, a kit for a latch mechanism system for retrofitting an existing cabinet door to make it earthquake and child proof is disclosed. The kit can comprise a threaded screw having a length greater than a width of a standard cabinet door and configured to couple with a cabinet door handle, a nut configured to couple with the screw, a bushing sized to fit within the hole, a lever arm having a threaded hole at one end and configured to frictionally couple with the screw so that it extends generally perpendicular to an axis of the screw, and a stopper configured to affix to the cabinet at a location spaced apart from the axis of the screw.

In some embodiments, the latch mechanism system can further comprise at least one spacer positioned between the cabinet and a head of the screw and configured to receive the screw therethrough. In some embodiments of the latch mechanism system, the lever arm can be positioned so that the door remains substantially adjacent to a frame of the cabinet or a second cabinet door without a gap therebetween. In some embodiments, the stopper can be configured to receive the lever arm to prevent opening of the cabinet door.

In some embodiments of the latch mechanism system, the at least one tensioning member can be at least one spring. In some embodiments the at least one tensioning member can be at least one spring washer. In some embodiments, the at least one tensioning member can be at least one bushing. In some embodiments, the at least one tensioning member can be a combination of at least one bushing and at least one spring.

In some embodiments, the screw can contain a notch at an end of the screw opposite the door handle, and the lever arm can comprise a shaped hole at an end that is configured to mate with the notch. In some embodiments, the shaped hole can be selected from the group consisting of an oval, a square, a triangle, or a D shaped hole.

In some embodiments, the at least one tensioning member can comprise a bushing having a longitudinal axis and comprising at least two longitudinal sections configured to expand outward when compressed to generate a frictional force on the door and the screw or lever arm. In some embodiments, the latch mechanism system can further comprise a metal or plastic sleeve configured to be inserted into the hole in the cabinet and further configured to accept the tensioning member.

In some embodiments, the lever arm can be configured to be breakable at an end opposite the screw. In some embodiments, the lever arm is configured to be bendable at an end opposite the screw.

In some embodiments, the stopper can be attached to a second cabinet door. In other embodiments, the stopper can be attached to a doorframe surrounding the cabinet.

In some embodiments, the tensioning member can be sized and configured to fit within a hole in the cabinet door.

In some embodiments, the kit can further comprise a wrench configured to turn the nut, a screwdriver configured to turn the screw, a drill bit configured to drill a hole sized for the screw along an axis equal to an axis defined by a fastener of the cabinet door handle, and a screw guide configured to guide the drill bit.

### BRIEF DESCRIPTION OF THE DRAWINGS

FIG. 1 illustrates an embodiment of the latch mechanism system mounted on an existing cabinet door and door handle.

FIG. 2 illustrates a view from behind a cabinet with a latch mechanism system.

FIG. 3 illustrates a side view of a latch mechanism system outside of a cabinet door.

FIG. 4 illustrates a side view of a latch mechanism system attached to a door handle outside of a cabinet door.

FIG. 5 illustrates a side view of a latch mechanism system without a spacer.

FIG. 6 illustrates a front view of a cabinet having one and two door configurations in which a latch mechanism system can be installed.

FIG. 7 illustrates an embodiment of a stopper on the back of a cabinet door.

FIG. 8 illustrates examples of different types of door handles on a front of a cabinet door that can be used with a latch mechanism system.

FIG. 9 illustrates a side view of the cabinet door with the latch mechanism system in the open position.

FIG. 10 illustrates the latch mechanism system of FIG. 9 in the closed position.

FIG. 11 illustrates another embodiment of a latch mechanism system.

FIG. 12 illustrates another embodiment of a latch mechanism system.

FIG. 13 illustrates another embodiment of a latch mechanism system.

FIG. 14 illustrates another embodiment of a latch mechanism system.

FIG. 15 illustrates another embodiment of a latch mechanism system.

FIG. 16 illustrates another embodiment of a latch mechanism system.

FIG. 17 illustrates another embodiment of the latch mechanism system.

FIGS. 18A-C illustrate another embodiment of a latch mechanism system.

FIG. 19 illustrates another embodiment of a latch mechanism system.

FIG. 20 illustrates another embodiment of a latch mechanism system.

FIG. 21 illustrates an embodiment of a lever arm for use in the latch mechanism systems of FIGS. 1-20.

FIG. 22 illustrates an embodiment of a latch mechanism kit.

### DETAILED DESCRIPTION

Any terms not directly defined herein shall be understood to have all of the meanings commonly associated with them as understood within the art. Certain terms are discussed below, or elsewhere in the specification, to provide additional guidance to the practitioner in describing the compositions, methods, systems, and the like of various embodiments, and how to make or use them. It will be appreciated that the same thing may be said in more than one way. Consequently, alternative language and synonyms may be used for any one or more of the terms discussed herein. No significance is to be placed upon whether or not a term is elaborated or discussed herein. Some synonyms or substitutable methods, materials and the like are provided. Recital of one or a few synonyms or equivalents does not exclude use of other synonyms or equivalents, unless it is explicitly stated. Use of examples in the specification, including examples of terms, is for illustrative purposes only and does not limit the scope and meaning of the embodiments herein.

The term “door handle,” as used herein, is a broad term and includes its ordinary dictionary meaning, and also refers to a generally handle-like shape that extends out of a cabinet door that allows for opening. Door handle can also include a lever arm or a knob, as well as any other shaped door handles and knobs that are contemplated.

The terms “cabinet door” or “cabinet” as used herein, are broad terms and include their ordinary dictionary meaning. However, the term cabinet door or cabinet is non-limiting and other types of structures such as, for example, a dresser, can also be used with the system disclosed below.

The term “screw” as used herein, is a broad term and includes its ordinary dictionary definition. However, the term screw is non-limiting and includes threaded screws having a longitudinal axis. A screw can be any type of screw, for example a machine or sheet metal screw, and the type of screw is not limiting.

Embodiments disclosed herein represent a latch mechanism system, or latch mechanism, for allowing a cabinet door to remain closed during an earthquake or to prevent opening of a door by a child. A latch mechanism with a rotatable lever arm can be attached to a preexisting or new door handle attached to a door, such as a cabinet. The door handle can be attached to the latch mechanism so that the door handle can be rotated in order to rotate the lever arm, thus latching or unlatching the cabinet door. The latch mechanism is simple with limited structural requirements, thus making installation relatively easy. Also, the latch mechanism can be set with increased or decreased requirements of force to turn a door handle, thereby adjusting the ease of opening up a cabinet (e.g., so that the cabinet door can be opened relatively easily by and adult or elderly individual, while inhibiting the opening of the cabinet door by a child). The latch mechanism does not require a lock, although a lock could be installed with the latch mechanism and is not limiting. Therefore, no external accessory, such as a key, is needed to open a cabinet door, or to fix the cabinet door in a closed position, using the disclosed latch mechanism.

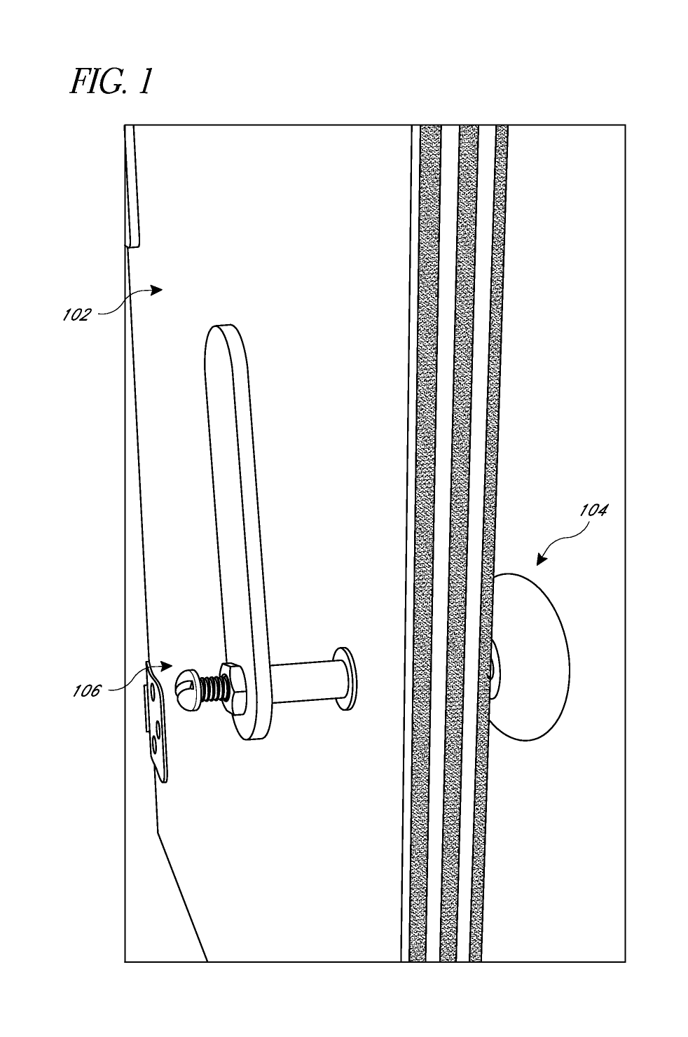

FIG. 1 illustrates one embodiment of the latch mechanism system. The cabinet door 102 can have a door handle 104. The latch mechanism system 106 can be placed on an existing cabinet door 102 and can be attached to a door handle 104 through a hole drilled through the cabinet door 102 from one side to the other. The door handle 104 can be a preexisting door handle already attached to the cabinet door 102 prior to installation of the latch mechanism 106, or the door handle 104 can be replaced with any other design of handle during installation of the latch mechanism 106. The latch mechanism 106 can be attached to the door handle 104 so that the latch mechanism 106 is configured to rotate with the rotation of the door handle 104 (e.g., rotate in unison with the rotation of the door handle 104), and so that the latch mechanism system 106 pivots about an axis of the door handle 104. Therefore, the cabinet door 102 will remained closed when the latch mechanism 106 is in a closed position, even if an opening force is placed on the door 102. When the door 102 is in the closed position, the door 102 is substantially flush, or adjacent and generally in contact with, with the rest of the cabinet, thereby inhibiting fingers from being inserted between the door 102 and the frame. By having the door 102 generally flush against the frame, with minimal or no gaps allowing insertion of an appendage, such as a finger, accidental injuries can be prevented. When the latch mechanism 106 is positioned in an open position, the cabinet door 102 can be opened with the approximately the same force as though the door 102 did not have a latch mechanism 106.

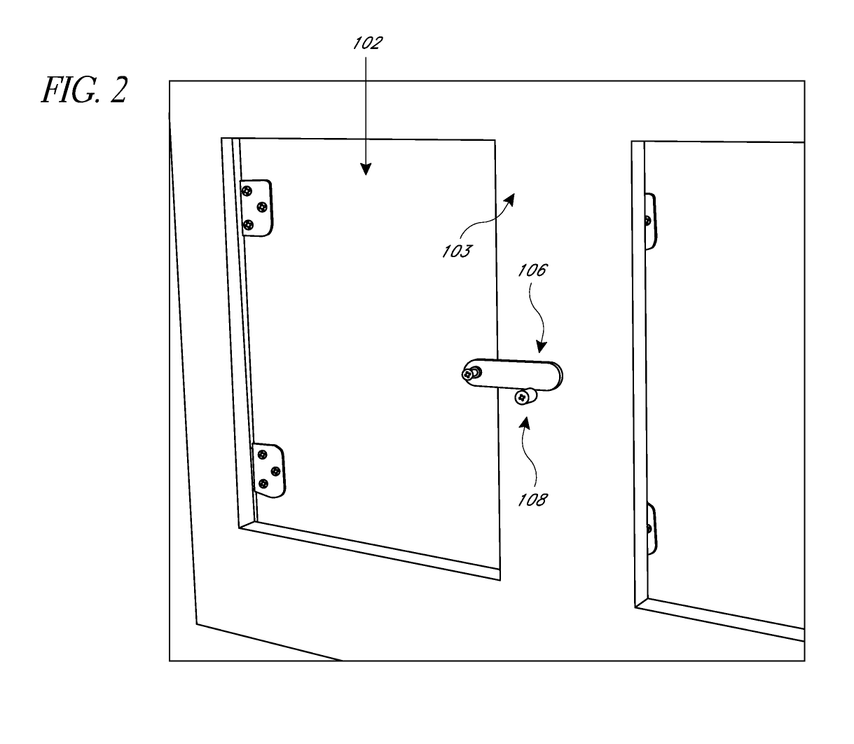

FIG. 2 illustrates the back of a cabinet door 102 with the latch mechanism 106. In some embodiments, as shown in the figure, the latch mechanism 106 can be rotated in an approximately circular manner along a plane parallel with the cabinet door 102, until it reaches a stopper 108 which stops rotation of the latch mechanism 106. In some embodiments, the stopper 108 is laterally spaced from the latch mechanism 106. In some embodiments, as shown in FIG. 2, the stopper 108 stops the rotation of the latch mechanism 106 behind the frame 103 of the cabinet. Therefore, when a pulling force is applied to the cabinet door 102, the latch mechanism 106 located against the frame 103 prevents opening of the door 102 and allows for only minimal, if any, motion of the cabinet door 102. When the latch mechanism 106 is stopped at the stopper 108, the cabinet door 102 can no longer be opened, and is in a latched position. When the latch mechanism 106 is rotated away from the stopper, such as in a vertical position or any position where the latching mechanism 106 is not located behind the cabinet frame 103, the cabinet door 102 can be opened. In some embodiments, the stopper 108 can be attached directly to the frame 103 surrounding the cabinet door 102 by screwing into the frame 103. However, other means and method for attachment of the stopper 108 to the cabinet frame 103 can be used.

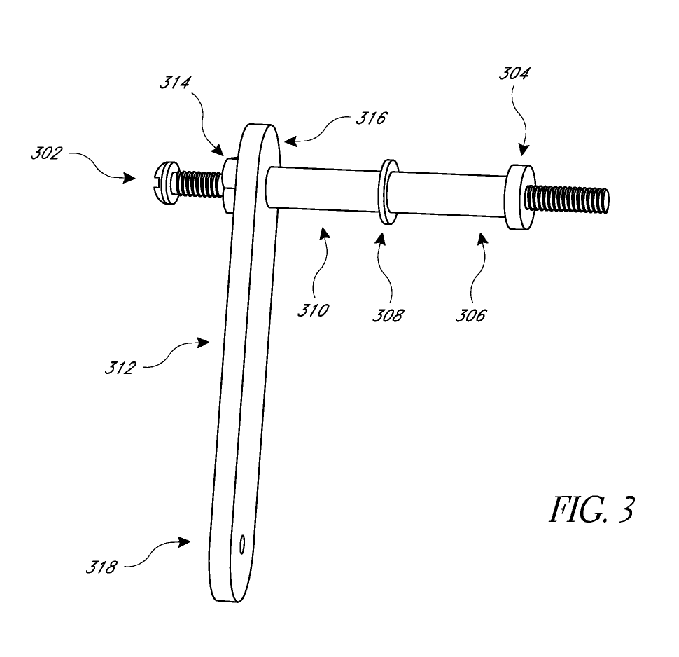

FIG. 3 illustrates an embodiment of a latch mechanism as removed from a cabinet door and a door handle. The latch mechanism 106 comprises a screw 302 with a longitudinal axis that can be threadably coupled to a door handle 104 on the same axis as the door handle 104 through a hole in the cabinet door 102, thus allowing the screw 302 to rotate with rotation of the door handle 104. In some embodiments, the screw 302 is an 8/32 in. or a 4 mm screw, as this is the common sizing that would allow the screw 302 to be coupled to a standard door handle. The screw can also be sized to extend greater than the width of the cabinet door 102. However, other screw sizes can be used with different door handles and the size is not limiting. The screw 302 protrudes through a set of pieces, described in an embodiment below, to form the latch mechanism 106. At the end of the screw 302 nearest the door handle 104, a first tensioning member 304 and a second tensioning member 306 can be configured to surround the screw 302 so the screw 302 runs through the center of the tensioning members 304/306. In one embodiment, the tensioning members can be of a resilient material so that the tensioning members can also be resilient members (e.g., resilient bushings), though in other embodiments, the tensioning members need not be resilient. In some embodiments, only one tensioning member 304 can be used. In some embodiments, the tensioning members 304/306 are threadably coupled to the screw 302. The tensioning members 304/306 can be made of different suitable materials and the material is not limiting. For example, in one embodiment the members 304/306 can be made of nylon, Teflon®, or other compressible materials. In some embodiments, the tensioning members 304/306 can be bushings with sized holes, such as ½ or ⅝ inch holes. The tensioning members 304/306 can be sized and configured to fit within a hole in the cabinet door 102. Moving past the tensioning members 304/306 and towards the head of the screw 302, the screw 302 can be surrounded by a washer 308. The washer 308 can be of any desired size to surround the screw 308. The material of the washer can be, for example, steel or aluminum, but the material is not limiting. Once the latch mechanism 106 is installed, at least one tensioning member 304/306 can be located within the hole of the cabinet door 102, and the washer 308 can be located outside the cabinet door 102 on the opposite side of the door 102 from the door handle 104. Moving further towards the head of the screw 308, the screw 302 can be surrounded by a spacer 310. The spacer 310 can be made out of nylon or Teflon®, but the material used for the spacer is not limiting. The spacer 310 can be of any desired size or shape to surround the screw 302. Moving further towards the head of the screw 302, a lever arm 312 can be configured to couple with the screw 302. The lever arm 312 can be held against the spacer 310 by a nut 314 to prevent unwanted movement of the lever arm 312. In some embodiments, the nut 314 can be a locking nut. However, other types of nuts can be used and the type of nut is not limiting. The material of the nut 314 is also not limiting. The nut 314 can be configured to threadably couple with the screw 302 and tightened so the lever arm 312 rotates with rotation of the screw 302, and thus the handle 104. In some embodiments, the lever arm 312 can be threadably coupled to the screw 312 at a first end 316. However, other methods of coupling can also be used and the method of coupling is not limiting. The lever arm 312 can extend from the first end 316 generally perpendicular to the longitudinal axis of the screw 302 to a second end 318.

When the door handle 104 rotates, the coupled screw 302 rotates with the door handle 104. The lever arm 312 can be held onto the screw 302 by the nut 314 and the spacer 310, so the lever arm 312 also rotates with the handle 104 (e.g., rotates in unison with the door handle 104). The rotation allows the lever arm 312 to rotate behind the frame 103 of the cabinet door 102 to latch and unlatch the cabinet door 102, as described above in reference to FIG. 2.

When the latch mechanism 106 is attached to the door handle 104, at least one tensioning member 304 or 306 can be located inside the cabinet door 102. In some embodiments, the combined length of the tensioning members 304/306 is greater than the width of the cabinet door 102. The tensioning members 304/306 can be made of a material that can be compressed. The specific compressible material is not limiting. Once the latch mechanism 106 is attached to the door handle 104 inside the door 102, the lever arm 312 can be rotated, causing compression of the tensioning members 304/306 within the cabinet door 102. This compression causes the tensioning members 304/306 to expand to fill the hole in the cabinet door 102 and tighten around the screw 302. Therefore, the compressed tensioning members 304/306 create a frictional force between the screw 302 and the cabinet door 102, thus resisting rotation of the door handle 104 and the lever arm 312. The lever arm 312 can also be rotated in the opposite direction thereby decompressing the tensioning members 304/306 and removing some of the frictional forces. By being able to compress and decompress the tensioning members 304/306, the frictional resistance for turning the door handle can be increased or decreased, therefore either increasing or decreasing the difficulty of turning the door handle 104. The tensioning members 304/306 can increase the friction inside the cabinet door 102 so a child would not have the strength to turn the door handle 104, once latched. However, an adult would still be able to turn the door handle 104 to latch and unlatch the cabinet door 102, effectively child proofing the cabinet. The friction would also stop the door handle 104 from turning during an earthquake, thereby earthquake proofing the cabinet. Advantageously, the friction can be adjustable and changed to allow for the desired difficulty of turning the door handle 104. The friction can be enough so that the door handle 104 will not move once rotated, for example by gravity or by vibrations during an earthquake.

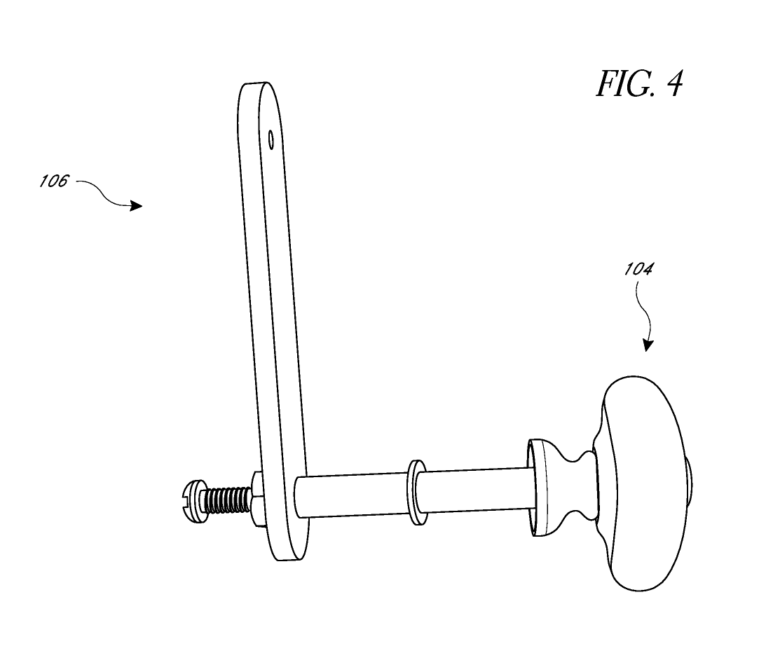

FIG. 4 illustrates an embodiment of the latch mechanism 106 attached to a door handle 104 without a cabinet door. As shown in the figure, the tensioning member 304 can be located within the door handle 104. However, in some embodiments, the tensioning member 304 could also protrude outside of the door handle 104.

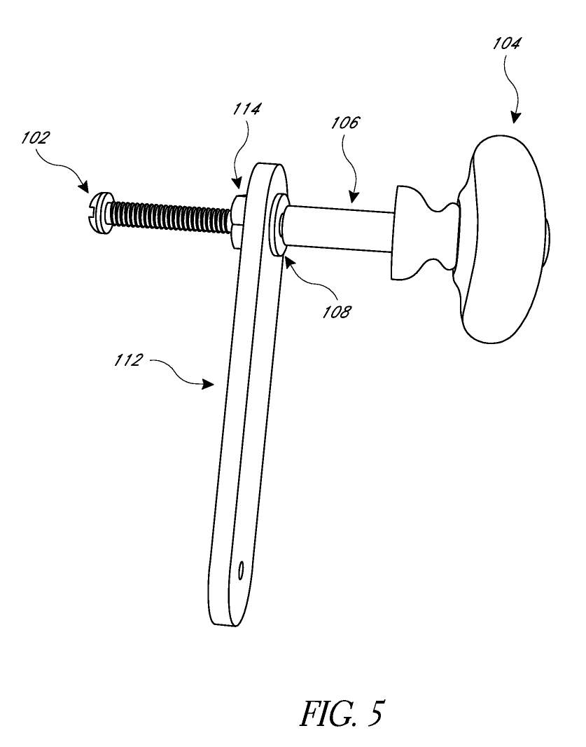

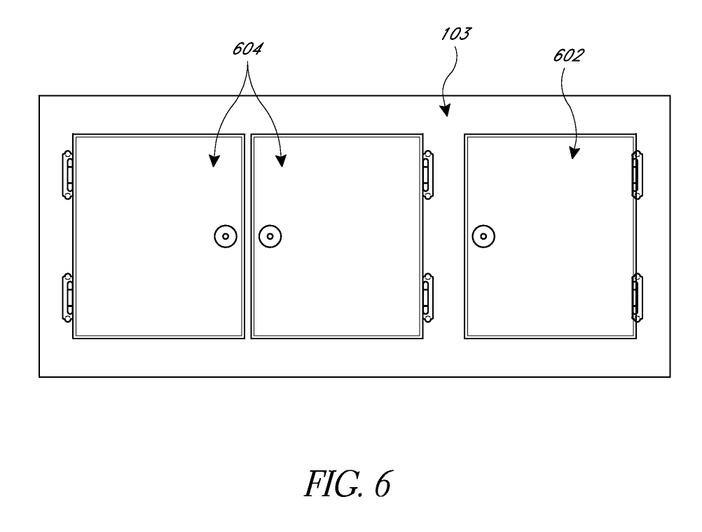

FIG. 5 illustrates another embodiment of a latch mechanism with a door handle 104 that is threadably coupled to a screw 102. The latch mechanism can also comprise at least one tensioning member 106 and a washer 108 and then a lever arm 112 which can be locked onto the door handle 104 with a nut 114. In this embodiment, no spacer is used, so the lever arm 112 can be almost directly located on a cabinet door 102 (e.g., adjacent the cabinet door 102) and can be only spaced away from the cabinet door 102 by the washer 108. The nut 114 can be tightened against the lever arm 112 to compress the arm 112 against the washer 108, thereby still allowing the lever arm 112 to rotate with the door handle 104. In this embodiment, a small stopper 108 can be used with the latch mechanism 106.

FIG. 6 illustrates different types of door sets that could be used with a latch mechanism. For example, a single door attached to a cabinet frame 103, as shown in 602, or a double door 604, where the door handles are directly next to each other and there is no frame 103 between them.

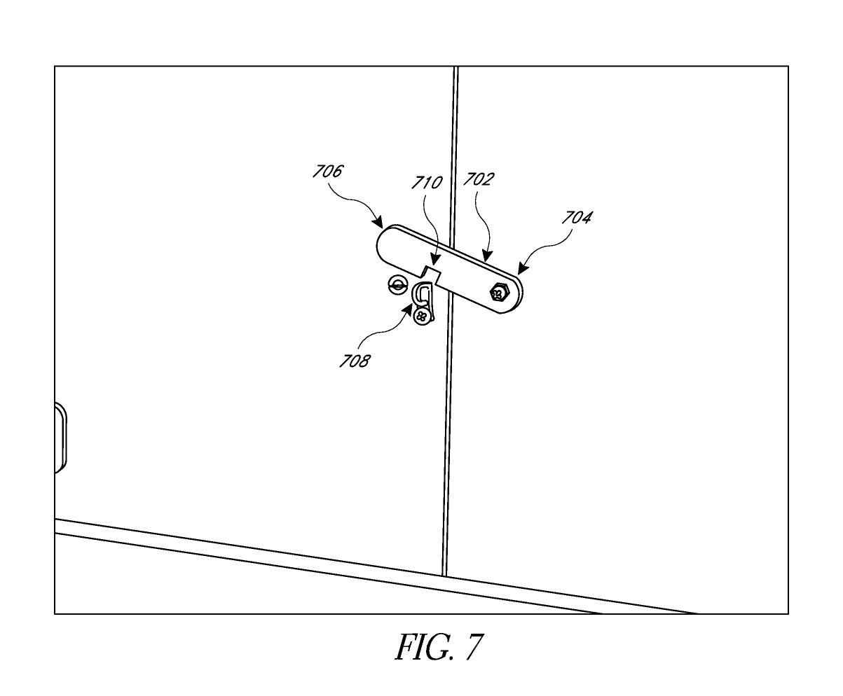

FIG. 7 illustrates an embodiment of a stopper where a double door configuration 604 is used and therefore a stopper cannot be located on the frame 103. The figure illustrates a lever arm 702 with a first end 704 attached to a door handle through a screw, as described above, and has a second end 706 extending perpendicular away from the screw. In some embodiments, a stopper 708 can be attached to the second door of the double door cabinet 604, which does not have a door handle attached to the latch mechanism 106. The stopper 708 can be configured to accept the lever arm 702 so that the stopper 708, when the lever arm 702 is placed inside, prevents the cabinet doors from being opened. For example, the stopper 708 can be L-shaped, as shown in FIG. 7. However, the shape of the stopper 708 is not limiting and the stopper 708 can have other suitable shapes (e.g., J shape, C shape). In other embodiments, the lever arm 702 contains a notch 710 and, therefore, the stopper 708 does not need to be configured to accept or receive the lever arm 708 but can, instead, be configured to merely extend outward behind the cabinet door with the extending end being sized and configured to be larger than the notch 710, thereby latching the doors when the notch 710 surrounds the stopper 708.

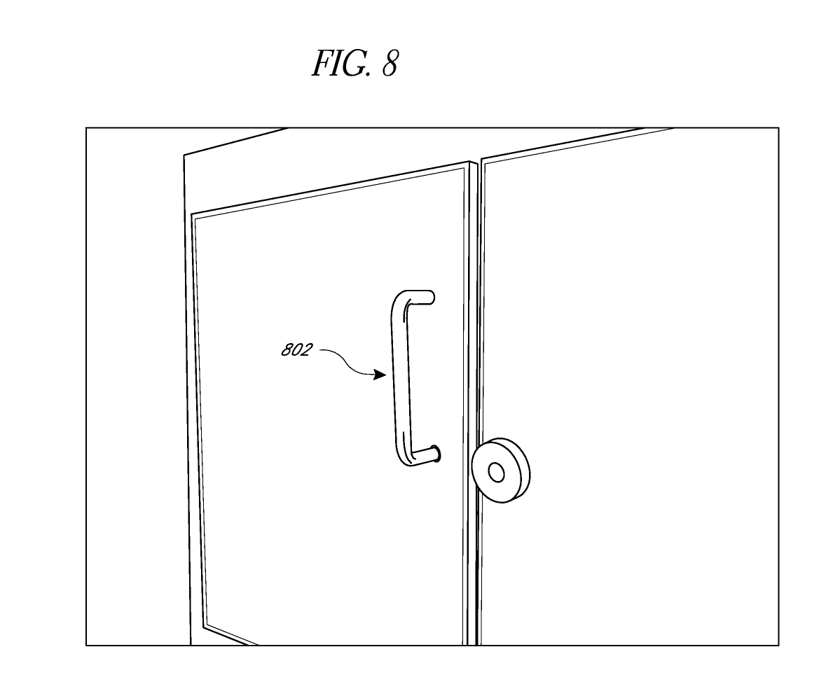

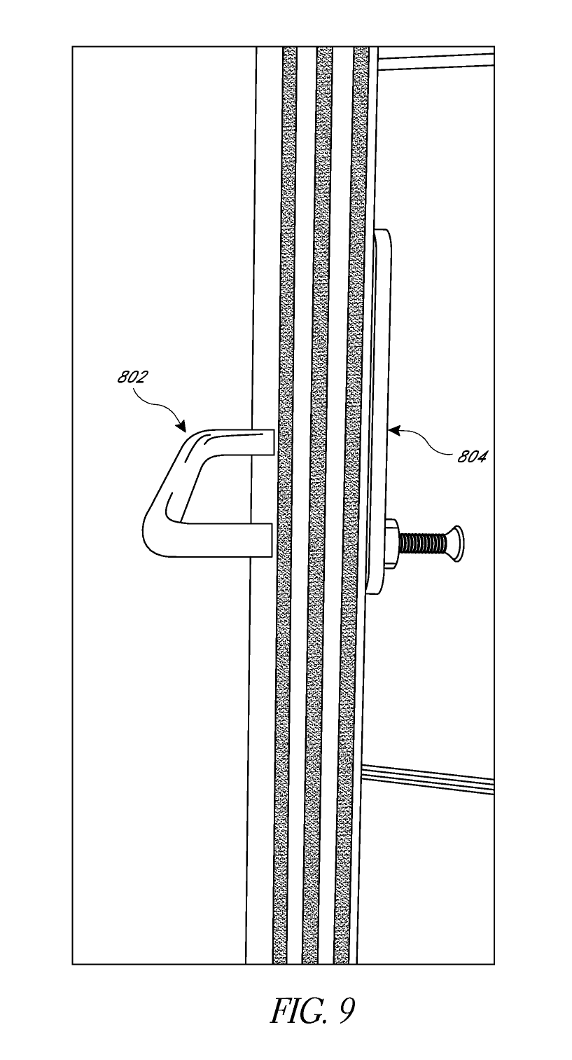

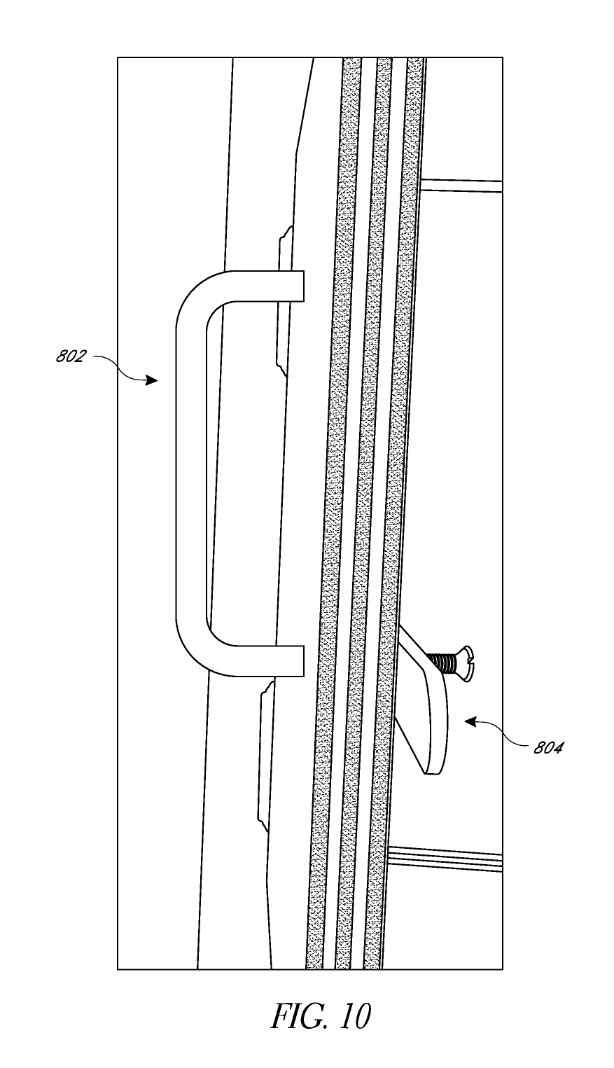

FIGS. 8-11 illustrate embodiments using a lever door handle. As mentioned above, the type of door handle is not limiting. FIG. 8 illustrates a closed door position of a two-door configuration with a door lever as a door handle 802. FIG. 9 illustrates the open door, where the door handle 802 sets a latch mechanism in an unlatched position as the lever arm 804 extends vertically. FIG. 10 illustrates an embodiment of the latch mechanism wherein the lever arm 804 extends horizontally and thereby latches the cabinet door.

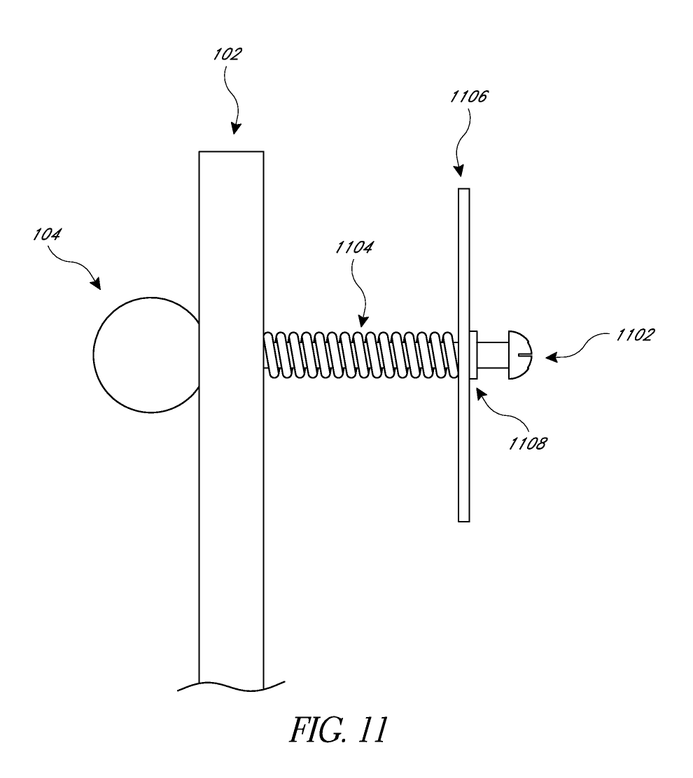

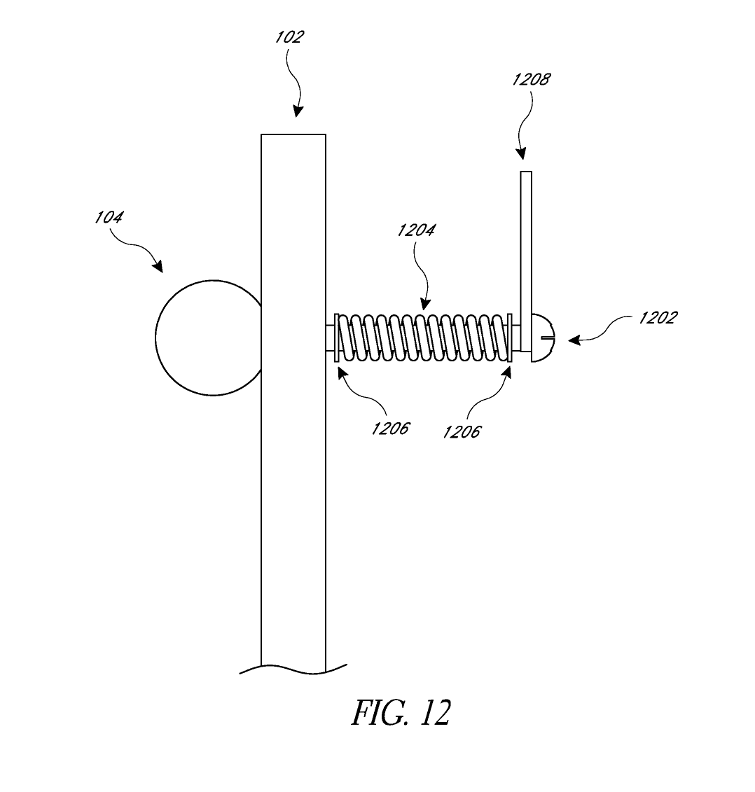

FIGS. 11-16 illustrate embodiments in where different types of spacers are used in between a cabinet door and the lever of a latch mechanism, such as, for example, the latch mechanism shown and described in FIG. 3.

FIG. 11 illustrates an embodiment with a cabinet door 102 and a door handle 104 attached to a cabinet door 102, wherein a screw 1102 is configured to attach to the door handle 104. A spring 1104 can be located between the cabinet door 102 and a lever arm 1106. The spring can be attached to the door 102 and the lever arm 1106 so that the latch mechanism is “spring loaded.” Therefore, the lever arm 1106 can be located in the “closed” position when the spring 1104 is not compressed. To turn the handle 104, and thus the lever arm 11606, into the desired position, the spring 1104 can be compressed, requiring higher turning force on the handle 104. A spring with the desired spring constant can be used to provide the desired resistance for opening the cabinet door 102. A nut 1108, such as a jam nut, can be used to hold the lever arm 1106 in the desired location.

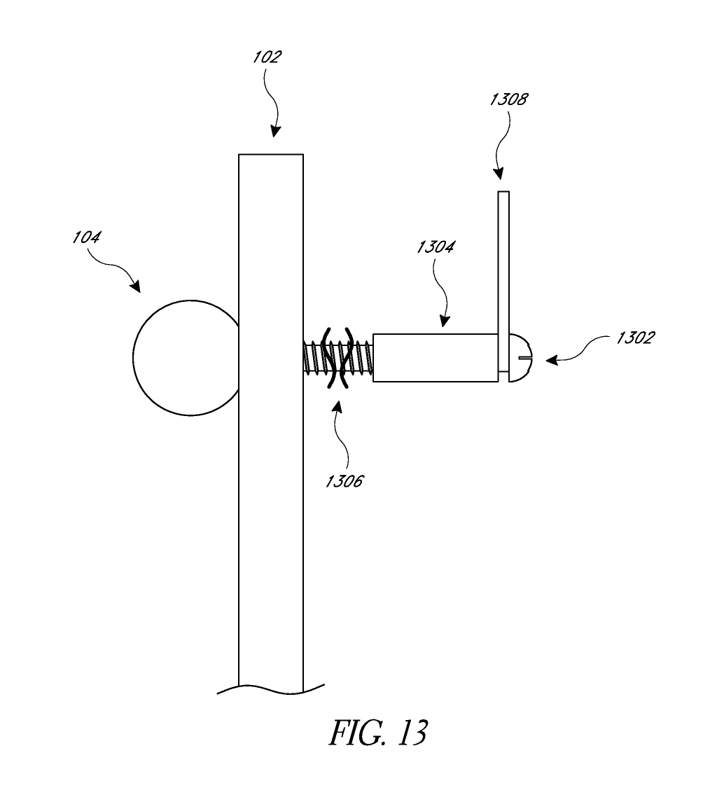

FIG. 12 illustrates another embodiment with a cabinet door 102 and a door handle 104 with a screw 1202 configured to attach to the door handle 104. In this embodiment, a spring 1204 can be located between two sets of washers 1206, all located outside of the cabinet door 102. The first washer can be against the cabinet door 102 followed by the spring, followed by the other washer, wherein a lever arm 1208 can be placed after one of the washers 1206 but before the end of the screw 1202, and the spring 1204 can have the spring constant so that the door handle 104 will turn with the lever arm 1208, or the lever arm 1208 will turn with the handle 104. The washers 1206 and spring 1204 can be configured to provide tension so the lever arm 1208 rotates with the rotation of the door handle 104. In some embodiments, a tensioning member may not be used inside the door 102. In other embodiments, the washers 1206 and spring 1204 can be combined with, or attached to, a tensioning member, for example tensioning member 306, inside the door 102. Use of tensioning members is described in some of the above embodiments.

FIG. 13 illustrates another embodiment of the latch mechanism with a cabinet door 102 and a handle 104. The screw 1302 can be attached to the door handle 104. In this embodiment, a bushing or a spring can be used 1304, at least one or two spring washers 1306 (e.g., Belleville washers, wave washers, curved disc springs) can be used and placed in opposite directions of each other, and placed near the cabinet door 102 to securely fasten the bushing 1304 and a lever arm 1308 so that the lever arm will turn with the turning of the door handle 104. The use of floppy washers 1306 is not limiting. A milled bushing could be used to the same extent. The spring washers 1306 and the bushing or spring 1304 can be configured to provide tension so the lever arm 1308 rotates with the rotation of the door handle 104. In some embodiments, a tensioning member may not be used inside the door 102. In other embodiments, the spring washers 1306 and spring or bushing 1304 can be combined with, or attached to, a tensioning member, for example tensioning member 306, inside the door 102. Use of tensioning members is described in some of the above embodiments.

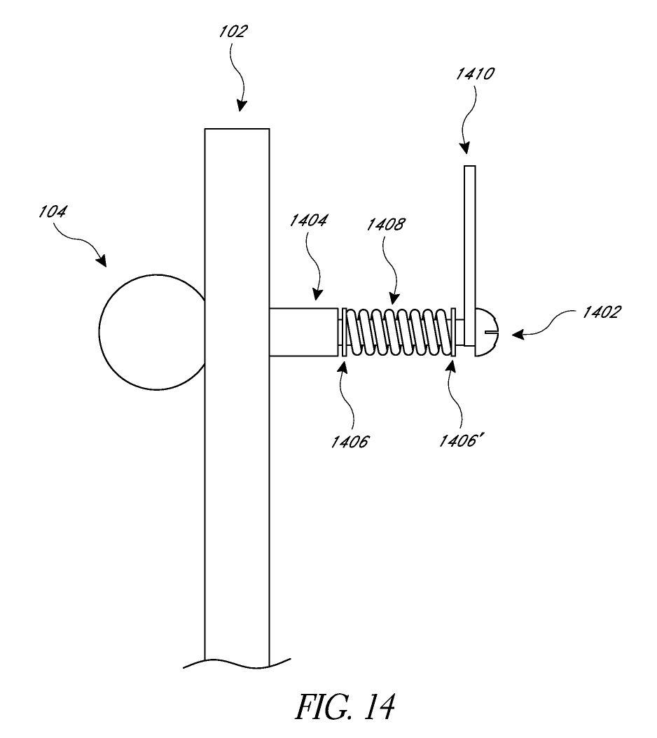

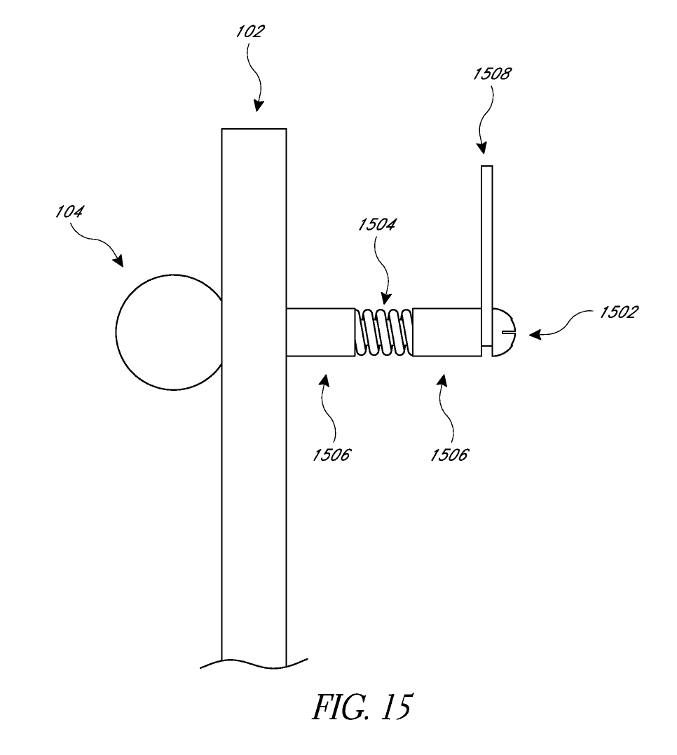

FIG. 14 illustrates another embodiment of the latch mechanism of a cabinet door 102 and a door handle 104 with a screw 1402 attached to the door handle 104. In this embodiment, a bushing 1404 can be placed directly against the cabinet door in the back of the door, followed by a washer 1406 and then a spring 1408, and then another washer 1406′, wherein a lever arm 1410 can be placed after the second washer 1406′, right before the head of the screw 1402, thus allowing the lever arm 1410 to turn with the rotation of the door handle 104. In some embodiments, the bushing 1404 and the spring 1408 can have switched positions. The bushing 1404 and spring 1408 can be configured to provide tension so the lever arm 1408 rotates with the rotation of the door handle 104. In some embodiments, a tensioning member may not be used inside the door 102. In other embodiments, the bushing 1404 and spring 1408 can be combined with, or attached to, a tensioning member, for example tensioning member 306, inside the door 102. Use of tensioning members is described in some of the above embodiments.

FIG. 15 illustrates another embodiment of the lever mechanism with a cabinet door 102 and a handle 104. In this embodiment, there are two bushings 1506 surrounding a spring 1504 so, as shown, there is first a cabinet door 102, then a first bushing 1506, then the spring 1504, then a second bushing 1506, afterwards which a lever arm can be inserted 1508 and the lever arm can be rotated with the rotation of the handle 104. The two bushings 1506 and spring 1504 can be configured to provide tension so the lever arm 1508 rotates with the rotation of the door handle 104. In some embodiments, a tensioning member may not be used inside the door 102. In other embodiments, the two bushings 1506 and spring 1504 can be combined with, or attached to, a tensioning member, for example tensioning member 306, inside the door 102. Use of tensioning members is described in some of the above embodiments.

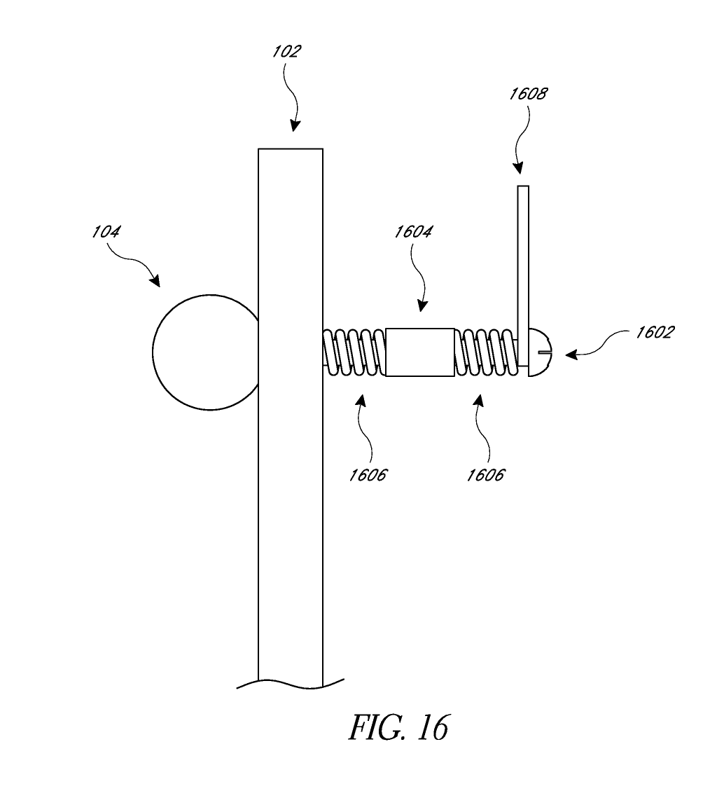

FIG. 16 illustrates an embodiment of the latch mechanism wherein there is a cabinet door 102 and a handle 104 and a screw 1602 attached to the door handle 104. In this embodiment, there can be two springs 1606 and one bushing 1604. The springs 1606 can surround the bushing 1604, thus allowing for different compressibilities of the springs. Therefore, as shown in FIG. 6, goes the cabinet door 102, springs 1606, bushing 1604, another spring 1606, wherein a lever arm 1608 can be located after the second spring 1606 but before the head of the screw 1602 so that the lever arm can be turned with rotation of the handle 104. The two springs 1606 and bushing 1604 can be configured to provide tension so the lever arm 1608 rotates with the rotation of the door handle 104. In some embodiments, a tensioning member may not be used inside the door 102. In other embodiments, the two springs 1606 and bushing 1604 can be combined with, or attached to, a tensioning member, for example tensioning member 306, inside the door 102. Use of tensioning members is described in some of the above embodiments.

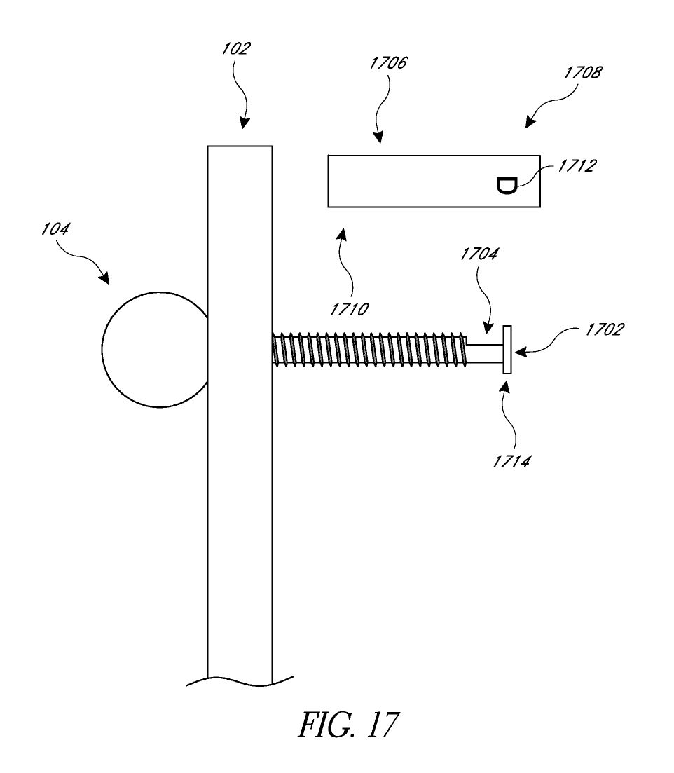

FIG. 17 illustrates another embodiment of a latch mechanism with a sized notch in a screw and a mating hole in a lever arm. The cabinet door 102 can have a door handle 104 which is attached to a screw 1702. The screw 1702 can have a notch cut into it 1704 at the end farthest from the door handle 104. In some embodiments, the screw 1702 can have the notch 1704 pre-cut into the screw 1702. The notch 1704 can be sized and configured to accept and fit with a shaped hole. In some embodiments, a lever arm 1706 with a first end 1708 and a second end 1710, comprises a shaped hole 1712 at the first end 1708 sized and configured to fit into the notch 1704 of the screw 1702. The mating of the hole 1712 and the notch 1704 prevents any motion of the lever arm 1706 without rotation of the screw 1702. A nut 1714 can be threadably coupled to the screw 1702, thus holding the lever arm 1706 on to the screw 1702. The hole 1712 of lever arm 1706 can be sized in different configurations to fit different configurations of the notch 1704. This can include, but is not limited to, an oval hole, a square hole, a triangle hole, or a D-shaped hole.

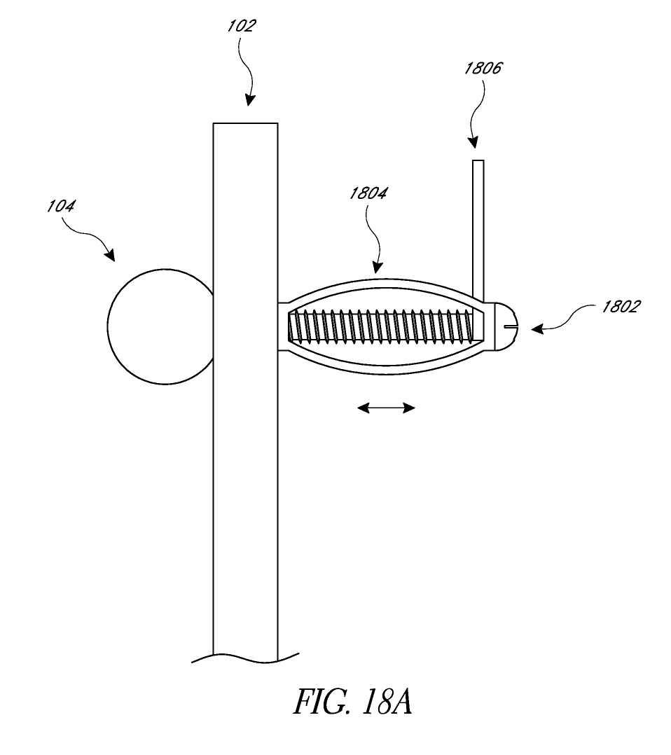

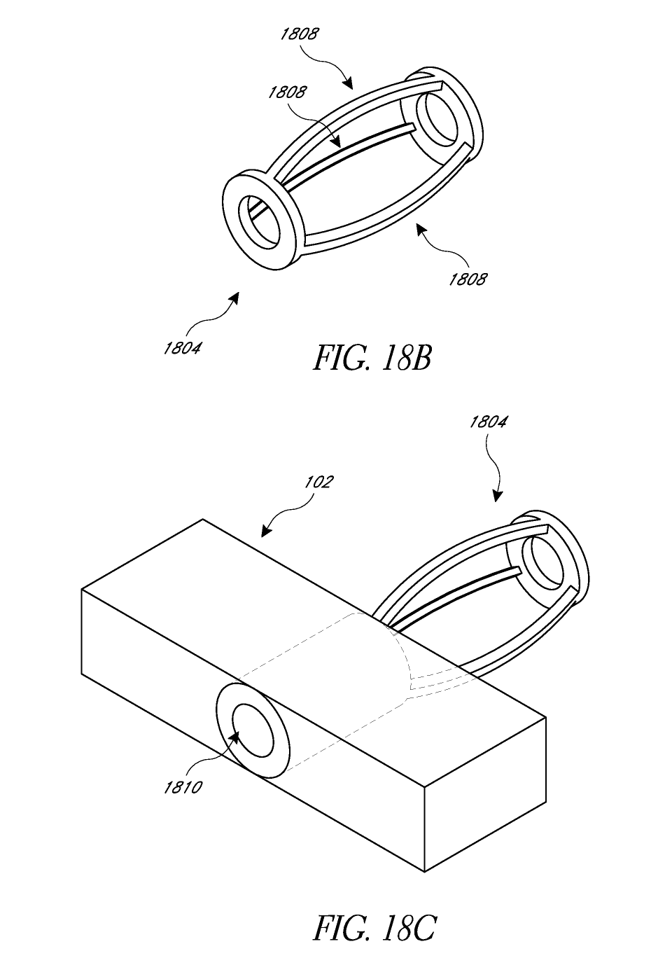

FIGS. 18A-18C illustrate embodiments using a split-piece bushing. FIG. 18A illustrates an embodiment with a cabinet door 102 and a door handle 104, wherein the screw 1802 is attached to the door handle 104. A bushing 1804 can be coupled with and surrounds the screw 1802, and the bushing 1804 can be located on the outside of the cabinet door 102. A lever arm 1806 can be attached to the end of the bushing 1804, as well as inside the bushing 1804. The lever arm 1806 can be held in place by the use of a nut, such as a jam nut. FIG. 18B illustrates the bushing 1804 on its own. The bushing 1804 can be sized and configured to split into two or more individual sections 1808 when compressed so that the bushing 1804 loses length but expands outward in diameter upon compression. Therefore, the bushing 1804 wants to regain its original shape and presses outwards towards the door 102 and the end of the screw 1802 or the lever arm 1806. This compression could take the place of tensioning members inside the door 102, and the compression could create frictional resistance in turning the door handle 102. Different compressible materials can be used for the bushing 1804 for desired frictional resistance, but the type of material is not limiting.

FIG. 18C illustrates an embodiment using the bushing 1804, wherein the split bushing is attached to a bushing 1810 inserted inside the door 102 so that they fit together and rotate together. The bushing 1804 can also be formed as one piece with the bushing 1810 and protrude into the cabinet door 102 as well as outside the cabinet door 102.

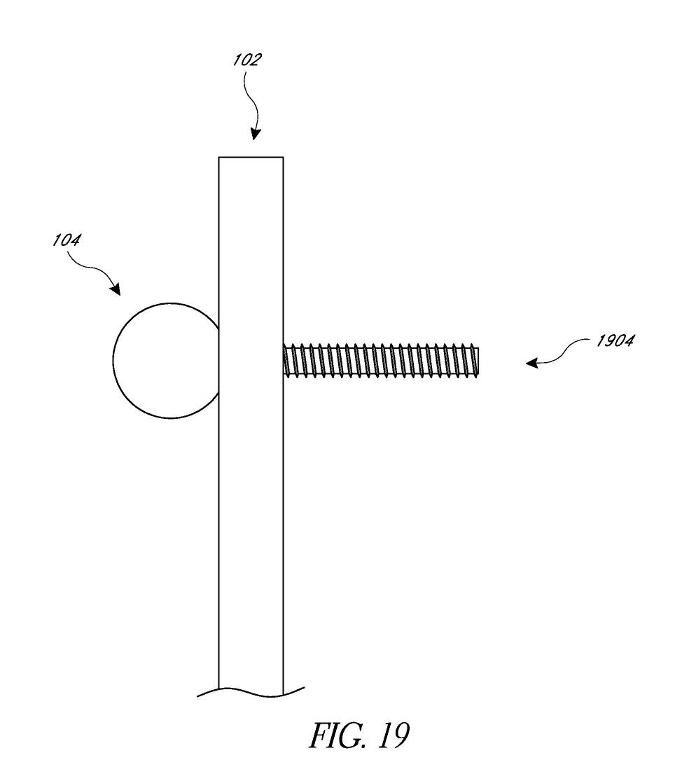

FIG. 19 illustrates another embodiment of the latch mechanism with a cabinet door 102. In this embodiment, the handle 1902 and the screw 1904 can be formed as one piece so that the screw 1904 does not have to screw into a door handle 1902 and therefore can be inserted into the door 102 as one piece. The above mentioned embodiments of the latch mechanism can be used appropriately with this embodiment, as well as other embodiments not disclosed.

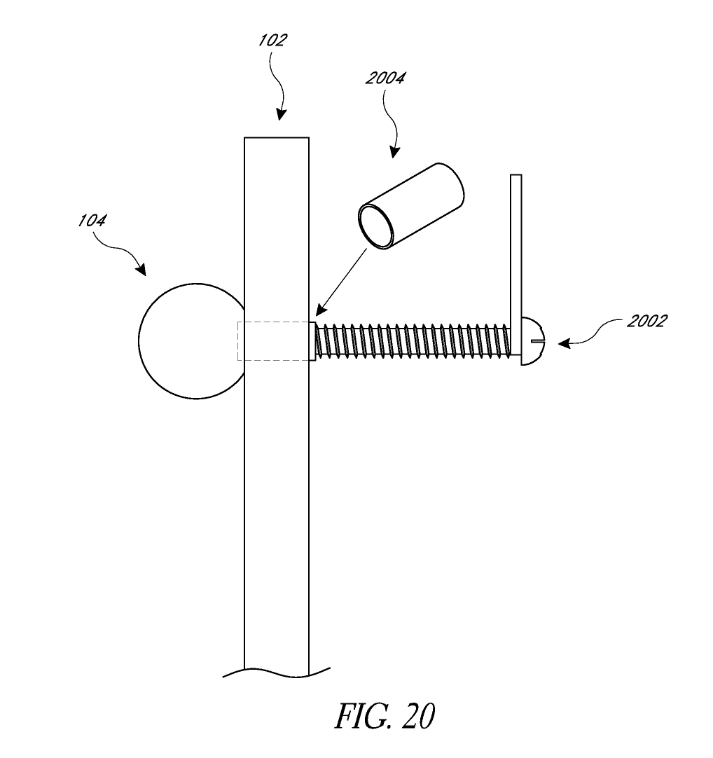

FIG. 20 illustrates another embodiment of the latch mechanism for use in a hollow or structurally weak door. The screw 2002 can be attached to the door handle 104. In this embodiment, a sleeve 2204 can be placed inside the door 104 and the sleeve 2204 can be configured to accept a tensioning member, such as ones described in FIG. 4. The sleeve can be metal or plastic, and the material of the bushing is not limiting. This embodiment can be especially useful when there is a hollow door and more structural integrity is needed inside the door 102. The sleeve 2204 allows for expansion of a tensioning member within the door 102 and sleeve 2204, which would otherwise damage the door 102 or not provide effective friction without the sleeve 2204. The above mentioned embodiments of the latch mechanism can be used appropriately with this embodiment, as well as other embodiments not disclosed.

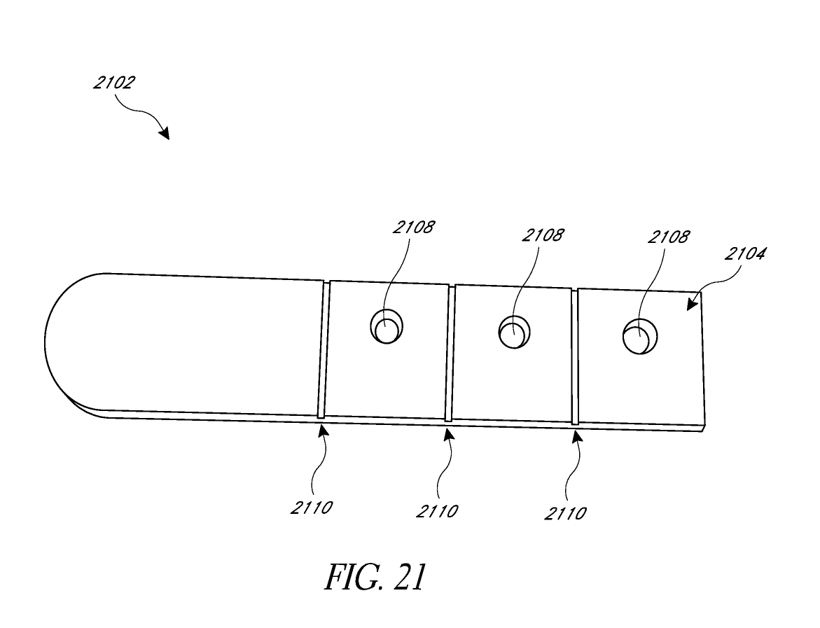

FIG. 21 illustrates an embodiment in which a lever arm 2102 can be configured to reduce in size by breaking off portions of the lever arm 2102 (e.g., the lever arm 2102 can have one or more frangible sections that can be broken off to adjust the length of the lever 2102). The lever arm 2102 has two ends 2104 and 2106, and end 2104 can comprise a hole 2108 configured to threadably couple with a screw. The lever arm 2102 can comprise multiple breakage points towards the end 2104 so that the breakage points 2110 can be broken off to reduce the length of the lever arm 2102. The lever arm 2102 can have multiple threadably coupled holes 2108 so that the lever arm 2102 can still be attached to a screw upon breakage. The break-off portions 2110 can also be located at the second end 2106 so that multiple holes 2108 are not needed and yet the lever arm 2102 can still be reduced in size. The second end 2106 can also be made of a flexible material so that the lever arm 2102 can be reduced in size by bending the flexible end 2106 without actually having to break off portions of the lever arm 2102, and thus the lever arm 2102 can both reduce in size and regain its original size. The lever arm 2102 described in this embodiment can be used in any of the above disclosed embodiments of the latch mechanism, along with other non-disclosed embodiments. Advantageously, the frangible sections allow the length of the lever arm 2102 to be adjusted, so the latch mechanism can be installed in a cabinet door, even when the amount of room on the frame for rotation of the lever is limited (e.g., when the cabinet door is close to a wall).

### Kit

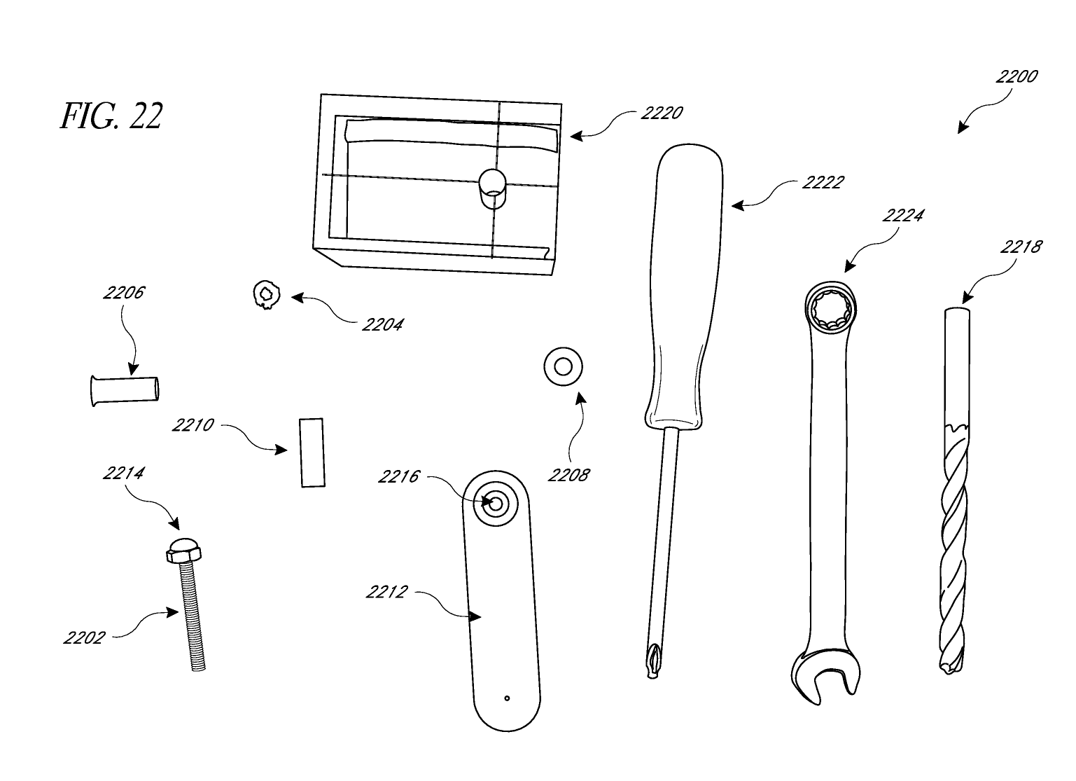

FIG. 22 illustrates an embodiment of a kit for a latch mechanism system. The kit 2200 can contain all of the pieces of the latch mechanism system described above. The items as described below can contain pieces with sizing, material, etc., described in the above embodiments and are not limiting. The kit can contain a screw 2202 sized to fit a door handle. The kit 2200 can also contain at least one tensioning member 2204. A second tensioning member 2206 can also be provided. A washer can 2208 can also be included in the kit 2200. A spacer 2210 can be included in the kit 2200. A lever arm 2212 and a nut 2214 can also be provided in the kit 2200. The nut 2214 can be a locking nut. The lever arm 2212 can contain a hole 2216 at one end sized to threadably couple with the screw 2202. Other variations of the latch mechanism system can also be provided in the kit, and the pieces disclosed are not limiting.

In some embodiments, one or more pieces of equipment for installing the latch mechanism system can be provided in the kit 2200. This equipment can include a drill bit 2218, a drill guide 2220, a screwdriver 2222 configured to turn the screw 2202, and/or a wrench 2224 configured to turn the nut 2214. Other equipment, for example hand drills and ratchet wrenches, can also be provided and the pieces disclosed above are not limiting.

Provided herein are various non-limiting examples of a device and kit for earthquake and child proofing a cabinet. While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separated from others.

What is claimed is:

1. A latch mechanism system for earthquake and child proofing an existing cabinet door comprising:
a pair of tensioning members sized to fit within a hole in a door of a cabinet from which a preexisting screw fastening a preexisting cabinet door handle has been removed, wherein the pair of members has a combined length greater than a width of the cabinet door;
a threaded screw having a longitudinal axis;
a lever arm having a threaded hole at one end and configured to threadably couple to the screw, wherein the lever arm extends generally perpendicular to the longitudinal axis of the screw;
a spacer configured to receive the screw therethrough, the spacer being positionable between a rear surface of the cabinet door and the lever arm;
a nut configured to threadably couple with the screw on an opposite side of the lever from the spacer, wherein the nut locks the lever arm against the spacer; and
a stopper configured to affix to the cabinet at a location laterally spaced apart from the axis of the screw, the stopper configured to stop movement of the lever arm;
wherein the screw is configured to extend through the pair of tensioning members and to couple with the preexisting door handle so that the screw extends in the same axis as the door handle; and
wherein the lever arm is configured to be rotated relative to the screw by a user rotating the door handle of the cabinet door, so as to compress the pair of tensioning members thereby frictionally engaging the door handle to the lever arm and causing the lever arm to rotate along with the door handle when the user rotates the door handle to latch and unlatch the cabinet door.

2. A latch mechanism system for retrofitting an existing cabinet door to make the cabinet door earthquake and child proof, comprising:
a screw configured to extend through a hole in a door of a cabinet and configured to couple with a door handle;
at least one tensioning member configured to generate a friction force on the screw;
a lever arm coupled with an end of the screw on an opposite side of the cabinet door from the door handle, the lever arm configured to extend generally perpendicular to the screw; and
a stopper affixed to a back side of the cabinet at a location spaced apart from the axis of the screw to stop rotation of the lever arm;
wherein the lever arm is frictionally engaged to the door handle via the screw and at least one tensioning member so that the lever arm rotates in unison with rotation of the door handle by a user.

3. A kit for a latch mechanism system for retrofitting an existing cabinet door to make it earthquake and child proof, comprising:
a threaded screw having a length greater than a width of a standard cabinet door and configured to couple with a cabinet door handle;
a nut configured to couple with the screw;
a bushing sized to fit within the hole;
a lever arm having a threaded hole at one end configured to frictionally couple with the screw so that it extends generally perpendicular to an axis of the screw; and
a stopper configured to affix to the cabinet at a location spaced apart from the axis of the screw.

4. The latch mechanism system of claim 2 further comprising at least one spacer positioned between the cabinet and a head of the screw and configured to receive the screw therethrough

5. The latch mechanism system of claim 2 wherein the lever arm is positioned so that the door remains substantially adjacent to a frame of the cabinet or a second cabinet door without a gap therebetween.

6. The latch mechanism system of claim 2 wherein the stopper is configured to receive the lever arm to prevent opening of the cabinet door.

7. The latch mechanism system of claim 2 wherein the at least one tensioning member is at least one spring.

8. The latch mechanism system of claim 2 wherein the at least one tensioning member is at least one spring washer.

9. The latch mechanism system of claim 2 wherein the at least one tensioning member is at least one bushing.

10. The latch mechanism system of claim 2 wherein the at least one tensioning member is a combination of at least one bushing and at least one spring.

11. The latch mechanism system of claim 2 wherein the screw contains a notch at an end of the screw opposite the door handle, and wherein the lever arm comprises a shaped hole at an end that is configured to mate with the notch.

12. The latch mechanism system of claim 11 wherein the shaped hole is selected from the group consisting of an oval, a square, a triangle, or a D shaped hole.

13. The latch mechanism system of claim 2 wherein the at least one tensioning member comprises a bushing having a longitudinal axis and comprising at least two longitudinal sections configured to expand outward when compressed to generate a frictional force on the door and the screw or lever arm.

14. The latch mechanism system of claim 2 further comprising a metal or plastic sleeve configured to be inserted into the hole in the cabinet and further configured to accept the at least one tensioning member.

15. The latch mechanism system of claim 2 wherein the lever arm is configured to be breakable at an end opposite the screw.

16. The latch mechanism of claim 2 wherein the lever arm is configured to be bendable at an end opposite the screw.

17. The latch mechanism system of claim 2 wherein the stopper is attached to a second cabinet door.

18. The latch mechanism system of claim 2 wherein the stopper is attached to a doorframe surrounding the cabinet door.

19. The latch mechanism system of claim 2 wherein the tensioning member is sized and configured to fit within the hole in the cabinet door.

20. The kit of claim 3, further comprising:
a wrench configured to turn the nut;
a screwdriver configured to turn the screw;
a drill bit configured to drill a hole sized for the screw along an axis equal to an axis defined by a fastener of the cabinet door handle; and
a screw guide configured to guide the drill bit.
